(19) United States
(12) Patent Application Publication
(10) Pub. No.: US 2025/0102961 A1
(43) Pub. Date: Mar. 27, 2025

(54) DEVELOPING APPARATUS AND IMAGE FORMING APPARATUS

(71) Applicant: FUJIFILM Business Innovation Corp., Tokyo (JP)

(72) Inventors: Norihiro TAMAZAWA, Kanagawa (JP); Tomoyuki YOSHII, Kanagawa (JP)

(73) Assignee: FUJIFILM Business Innovation Corp., Tokyo (JP)

(21) Appl. No.: 18/593,995

(22) Filed: Mar. 4, 2024

(30) Foreign Application Priority Data
Sep. 26, 2023 (JP) 2023-163722

(51) Int. Cl. G03G 15/08; G03G 21/10

(52) U.S. Cl. CPC G03G 15/0898; G03G 21/105

(57) ABSTRACT

A developing apparatus includes a developer holder that supplies a developer to an image holder on which an electrostatic latent image is formed; a regulation member that regulates an amount of the developer held by the developer holder; a shielding member that covers a part of the developer holder and the regulation member; and a suction portion that has, in a covering region covered by the shielding member of the developer holder, a first flow path allowing air to flow in from a first inlet provided on a downstream side of a movement of the developer holder, and a second flow path allowing air to flow in from a second inlet provided on an upstream side of the movement of the developer holder, and that sucks the air via the first flow path and the second flow path.

### CROSS-REFERENCE TO RELATED APPLICATIONS

This application is based on and claims priority under 35 USC 119 from Japanese Patent Application No. 2023-163722 filed Sep. 26, 2023.

### BACKGROUND

### (i) Technical Field

The present invention relates to a developing apparatus and an image forming apparatus.

### (ii) Related Art

In an image forming apparatus using an electrophotographic method, in order to suppress the leakage of a developer from a developing apparatus, a shielding member that covers a part of a developer holder to suppress scattering of the developer and a flow path that sucks and collects the developer are provided.

JP6010058B discloses that a duct that communicates with a facing region between a toner carrier and a toner supply body via a through-hole is provided and an airflow is formed from a space near the facing region via the duct toward an exhaust device by creating a negative pressure inside the duct by the exhaust device.

JP4752663B discloses that a cover that covers a part of a developer carrier is provided, an outlet through which air between the developer carrier and a distal end of the cover flows out is formed, an inlet for air is formed in the cover, the flow of the air in one direction from the inlet toward the outlet is formed along the developer carrier.

### SUMMARY

In a case where the amount of the developer scattered inside the developing apparatus is increased, the developer leaking out from the shielding member cannot be completely collected, which causes a decrease in the quality of an image to be formed.

An object of the present invention is to collect the developer staying on the inner side of the shielding member and the regulation member of the developing apparatus more efficiently as compared with a configuration in which the developer leaking out from the shielding member is collected by sucking the air from the downstream side of the shielding member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing apparatus including a developer holder that supplies a developer to an image holder on which an electrostatic latent image is formed; a regulation member that regulates an amount of the developer held by the developer holder; a shielding member that covers a part of the developer holder and the regulation member; and a suction portion that has, in a covering region covered by the shielding member of the developer holder, a first flow path allowing air to flow in from a first inlet provided on a downstream side of a movement of the developer holder, and a second flow path allowing air to flow in from a second inlet provided on an upstream side of the movement of the developer holder, and that sucks the air via the first flow path and the second flow path.

### BRIEF DESCRIPTION OF THE DRAWINGS

Exemplary embodiment(s) of the present invention will be described in detail based on the following figures, wherein:

FIG. 1 is a diagram illustrating an image forming apparatus to which the present exemplary embodiment is applied;

FIG. 2 is a perspective view illustrating an internal configuration of a developing device;

FIG. 3 is a cross-sectional view illustrating the internal configuration of the developing device;

FIG. 4 is a diagram illustrating a main part of the developing device illustrated in FIG. 3, in an enlarged manner; and

FIG. 5 is a diagram illustrating a discharge route of the developer continuing from a space illustrated in FIG. 3.

### DETAILED DESCRIPTION

Hereinafter, exemplary embodiments of the invention will be described in detail with reference to the accompanying drawings.

### Configuration of Image Forming Apparatus

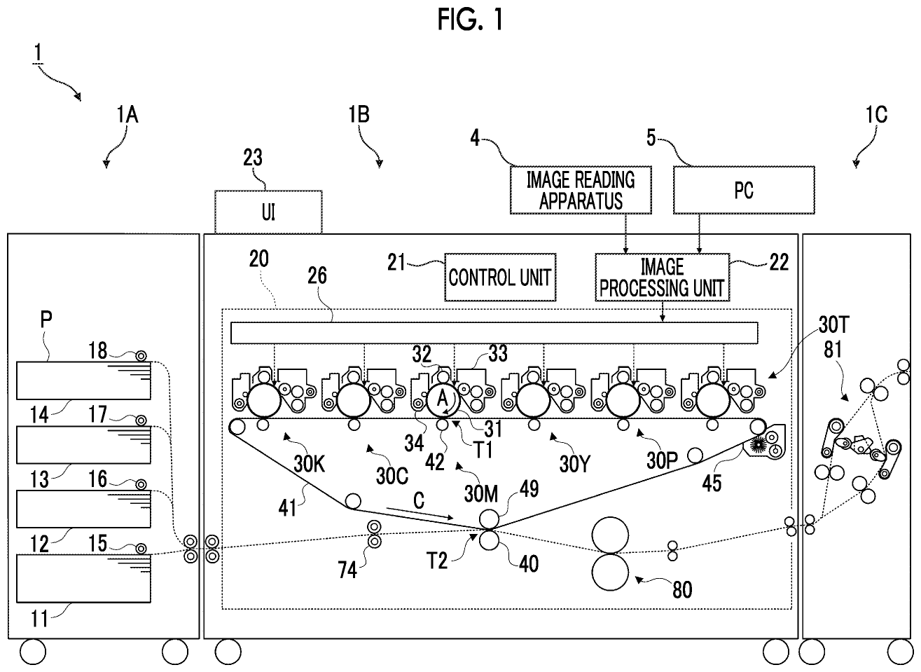

FIG. 1 is a diagram illustrating an image forming apparatus 1 to which the present exemplary embodiment is applied. The image forming apparatus 1 according to the present exemplary embodiment includes a paper feeding unit 1A, a printing unit 1B, and a paper discharge unit 1C. The paper feeding unit 1A includes a first paper accommodation portion 11 to a fourth paper accommodation portion 14 that accommodate paper P as an example of a recording medium. In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1. In addition, the printing unit 1B also includes an image processing unit 22. The image processing unit 22 performs image processing on image data transmitted from an image reading apparatus 4 and a personal computer (PC) 5. In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals. Each image forming unit 30 includes a photosensitive drum 31 on which an electrostatic latent image is formed while rotating in a direction of arrow A, a charging roll 32 that charges a surface of the photosensitive drum 31, a developing device 33 that develops the electrostatic latent image formed on the photosensitive drum 31, and a drum cleaner 34 that removes toner or the like on the surface of the photosensitive drum 31.

In addition, the image forming portion 20 is provided with an exposure device 26 that exposes each photosensitive drum 31 of each image forming unit 30 with laser light. Note that the exposure of the photosensitive drum 31 by the exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner accommodated in the developing device 33. The image forming units 30Y, 30M, 30C, and 30K form yellow (Y), magenta (M), cyan (C), and black (K) toner images, respectively. In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred. In addition, the image forming portion 20 is provided with a primary transfer roll 42 that transfers each color toner image of each image forming unit 30 onto the intermediate transfer belt 41 at a primary transfer portion T1. In addition, the image forming portion 20 is provided with a secondary transfer roll 40 that transfers the toner images transferred onto the intermediate transfer belt 41 all at once onto the paper P at a secondary transfer portion T2. Further, the image forming portion 20 is provided with a belt cleaner 45 that removes toner or the like on the surface of the intermediate transfer belt 41, and a fixing device 80 that fixes the secondarily transferred image onto the paper P.

The image forming portion 20 performs an image forming operation on the basis of a control signal from the control unit 21. Specifically, in the image forming portion 20, first, image processing is performed by the image processing unit 22 on the image data input from the image reading apparatus 4 or the PC 5, and the image data after the image processing is performed is supplied to the exposure device 26. Then, for example, in the image forming unit 30M for magenta (M), after the surface of the photosensitive drum 31 is charged by the charging roll 32, the photosensitive drum 31 is irradiated by the exposure device 26 with the laser light modulated with the image data obtained from the image processing unit 22.

In this manner, the electrostatic latent image is formed on the photosensitive drum 31. The formed electrostatic latent image is developed by the developing device 33, and a magenta toner image is formed on the photosensitive drum 31. Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41. The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route. In a case where the superimposed toner images are conveyed to the secondary transfer portion T2, the paper P is supplied from the registration roll 74 to the secondary transfer portion T2 at the same time. Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80. In the fixing device 80, the paper P on which the unfixed toner image is formed is pressurized and heated, and fixing processing of the toner image on the paper P is performed. Then, the paper P on which the fixing processing has been performed is conveyed to a paper stacking portion (not illustrated) after passing through a curl correction portion 81 provided in the paper discharge unit 1C.

### Configuration of Developing Device 33

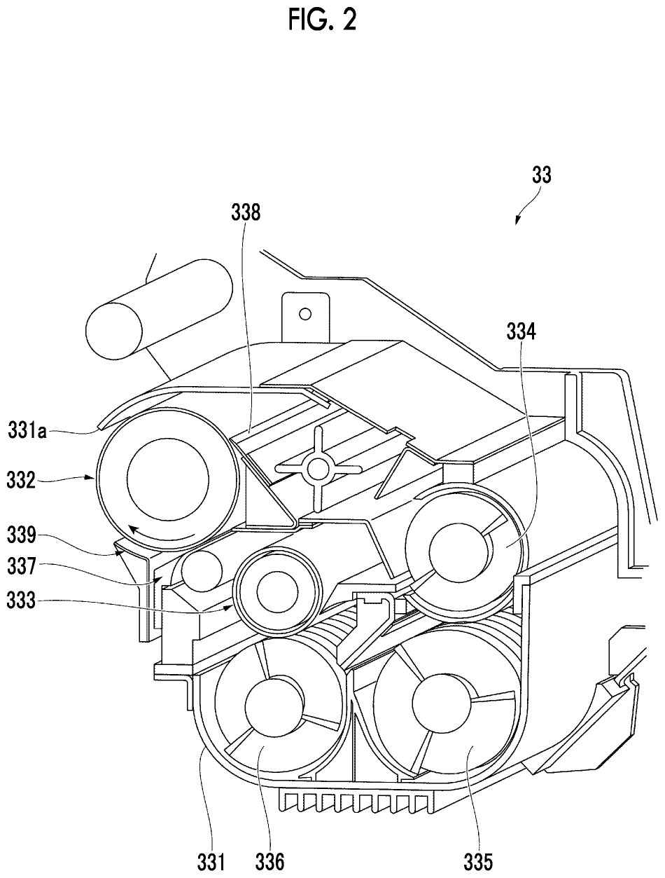

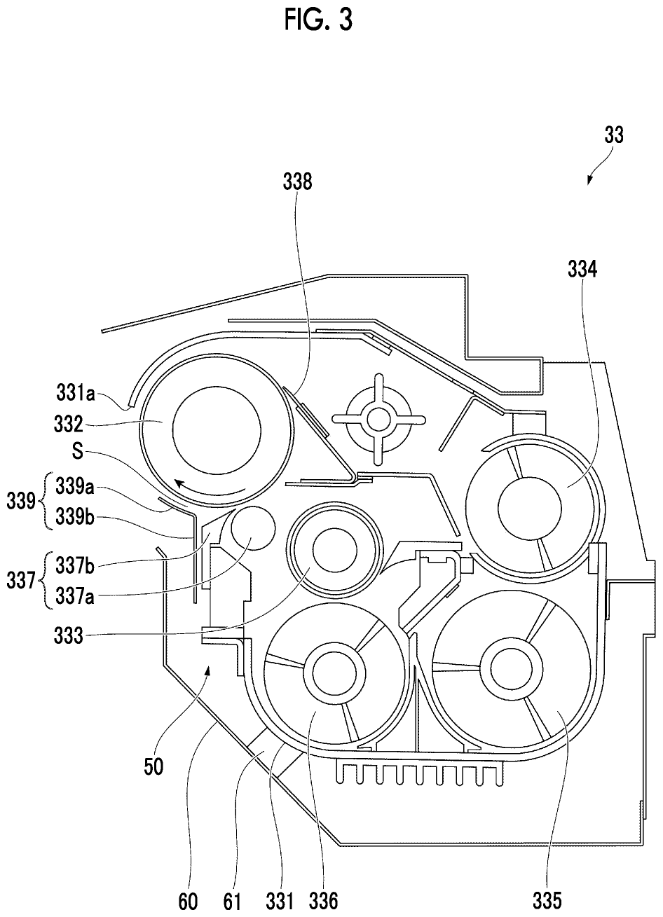

FIGS. 2 and 3 are diagrams illustrating the internal configuration of the developing device 33. FIG. 2 is a perspective view of the developing device 33 viewed from the front side (front side of the paper surface of FIG. 1) of the printing unit 1B of the image forming apparatus 1 illustrated in FIG. 1 to the rear side (back side of the paper surface of FIG. 1), and is a cross-sectional view with the front side cut away. FIG. 3 is a diagram of the developing device 33 viewed from the front side to the rear side, and is a cross-sectional view with the front side cut away.

The developing device 33 has an accommodation portion 331 consisting of a housing arranged to extend from the front side to the rear side of the printing unit 1B, at a position adjacent to the photosensitive drum 31. The accommodation portion 331 is provided with an opening portion 331a at a position facing the photosensitive drum 31. Inside the accommodation portion 331, together with the developer, a developing roll 332, a pickup roll 333, a first conveyance portion 334, a second conveyance portion 335, a third conveyance portion 336, a regulation member 337, and a removal member 338 are accommodated. A cover 339 for suppressing scattering of the developer is provided below the opening portion 331a of the accommodation portion 331. The members inside the accommodation portion 331 are elongated members having approximately the same length, and are arranged substantially in parallel. The developer accommodated in the accommodation portion 331 includes a mixture of toner for forming an image and carrier as magnetic particles for transporting the toner. In addition, each member included in the accommodation portion 331 is covered with an outer shell 60. The developing device 33 is an example of a developing device unit.

The developing roll 332 includes a shaft member having a columnar shape, and a sleeve that covers the shaft member and has a cylindrical shape. The developing roll 332 is arranged such that a part of a side surface of the developing roll 332 is exposed through the opening portion 331a of the accommodation portion 331 and the exposed surface faces the photosensitive drum 31. The shaft member of the developing roll 332 has magnetic force, and the sleeve rotates around the shaft member in a direction of the illustrated arrow. In the developing roll 332, the developer is stuck onto the surface of the sleeve due to the magnetic force of the shaft member, the developer is transported to the opening portion 331a due to the rotation of the sleeve, and the toner adheres to the charged photosensitive drum 31 to develop the electrostatic latent image. The developing roll 332 is an example of the developer holder.

The pickup roll 333 is provided to be parallel to and adjacent to the developing roll 332. The pickup roll 333 includes a shaft member having a columnar shape, and a sleeve that covers the shaft member and has a cylindrical shape. The shaft member has magnetic force, and the sleeve rotates around the shaft member. In the pickup roll 333, the developer is stuck onto the surface of the sleeve due to the magnetic force of the shaft member, the developer is transported to be delivered to the developing roll 332 due to the rotation of the sleeve.

Each of the first conveyance portion 334, the second conveyance portion 335, the third conveyance portion 336 is an auger having a spiral blade around a rotation shaft. The first conveyance portion 334, the second conveyance portion 335, the third conveyance portion 336 are arranged inside the accommodation portion 331 such that the rotation shaft is parallel to the developing roll 332 and the pickup roll 333. Each of the first conveyance portion 334, the second conveyance portion 335, and the third conveyance portion 336 rotates around the rotation shaft, and thus the developer is agitated and conveyed in a direction along the rotation shaft of each of the conveyance portions 334 to 336. In addition, along with the rotational movements of the first conveyance portion 334, the second conveyance portion 335, and the third conveyance portion 336, the developer is conveyed in the order of the first conveyance portion 334, the second conveyance portion 335, and the third conveyance portion 336, and is supplied from the third conveyance portion 336 to the pickup roll 333.

The regulation member 337 is provided along the side surface of the developing roll 332, on the downstream side of a position where the developing roll 332 faces the pickup roll 333 and on the upstream side of a position where the developing roll 332 faces the photosensitive drum 31. Here, the downstream side and the upstream side are the downstream side and the upstream side of the developing roll 332 in the rotation direction. The regulation member 337 scrapes off the developer that is supplied from the pickup roll 333 and held on the surface of the developing roll 332 to regulate the developer to a constant height. The developer scraped off by the regulation member 337 is collected inside the accommodation portion 331, and returns to the conveyance route including the first conveyance portion 334, the second conveyance portion 335, and the third conveyance portion 336.

More specifically, the regulation member 337 includes a regulation roll 337a and a regulation blade 337b that are arranged at a constant interval from the surface of the developing roll 332. The regulation roll 337a is a roll member that is arranged such that an axial center direction thereof is parallel to an axial center direction of the developing roll 332, and presses the developer supplied from the pickup roll 333 to the developing roll 332 such that the developer has a constant height from the surface of the developing roll 332. The regulation blade 337b is a blade that extends parallel to the axial center direction of the developing roll 332, and scrapes off the developer at the tip part of the layer such that the layer of the developer that is pressed by the regulation roll 337a has a constant height. The developer scraped off by the regulation blade 337b falls downward from between the regulation roll 337a and the regulation blade 337b, and is collected inside the accommodation portion 331.

The removal member 338 is provided along the side surface of the developing roll 332, on the downstream side of a position where the developing roll 332 faces the photosensitive drum 31. The downstream side is the downstream side of the developing roll 332 in the rotation direction. The removal member 338 scrapes off the developer remaining on the surface of the developing roll 332 after the developing roll 332 supplies the developer to the photosensitive drum 31. The developer that has been scraped off from the developing roll 332 by the removal member 338 is collected inside the accommodation portion 331, and returns to the conveyance route including the first conveyance portion 334, the second conveyance portion 335, and the third conveyance portion 336.

The cover 339 is a member that suppresses the exposure of the developing roll 332 at the opening portion 331a of the accommodation portion 331. The cover 339 includes a cover portion 339a that covers the surface of the developing roll 332 at a certain interval from the surface, and a guide piece 339b that extends downward from one end side of the cover portion 339a. The cover portion 339a is a plate-shaped member that has an arc-shaped cross section along the surface of the developing roll 332, and covers the surface of the developing roll 332 to suppress scattering of the developer. The guide piece 339b is provided at an edge of the cover portion 339a on the upstream side in the rotation direction of the developing roll 332 to be far away from the developing roll 332. The guide piece 339b is provided parallel to the regulation blade 337b to cover the regulation blade 337b at a certain interval from the regulation blade 337b of the regulation member 337. The cover 339 is an example of the shielding member. The developer separated from the surface of the developing roll 332 after passing through the regulation blade 337b passes through a gap between the guide piece 339b and the regulation blade 337b to be discharged from a space S surrounded by the surface of the developing roll 332, the cover portion 339a, and the regulation blade 337b.

A support block 61 that supports the accommodation portion 331 is provided inside the outer shell 60, and a space between the accommodation portion 331 and the outer shell 60 is partitioned by the support block 61 to form a space 50. The space 50 is continuous from the front side to the rear side of the developing device 33, and is a discharge flow path (duct) for discharging the developer that has flowed out to the outside of the accommodation portion 331 from the gap between the cover 339 and the regulation blade 337b or from the opening portion 331a.

Discharge of Developer Separated from Developing Roll 332

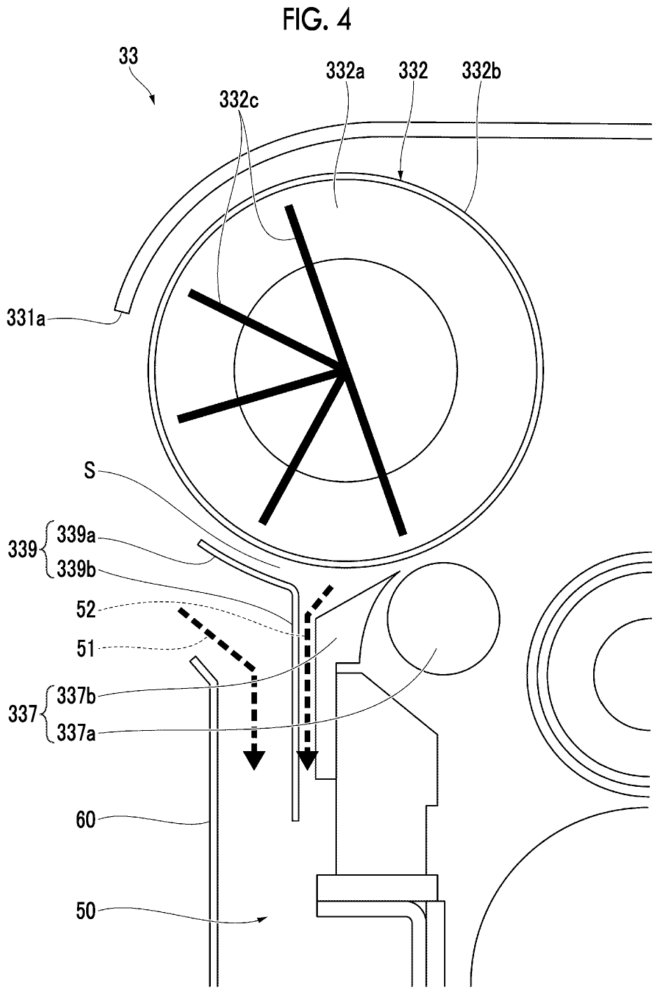

FIG. 4 is a diagram illustrating a main part of the developing device 33 illustrated in FIG. 3, in an enlarged manner. The discharge of the developer separated from the surface of the developing roll 332 will be further described with reference to FIGS. 2 to 4. First, the transportation of the developer by the developing roll 332 will be described.

As described above, the developing roll 332 includes a shaft member 332a that has magnetic force, and a sleeve 332b that has a cylindrical shape and is rotatable around the shaft member 332a. The shaft member 332a of the developing roll 332 is provided with a plurality of magnetic poles 332c. In the example illustrated in FIG. 4, five magnetic poles 332c are radially provided in a semicircular part of the cross section of the shaft member 332a, the semicircular part being close to the opening portion 331a of the accommodation portion 331. The magnetic poles 332c are arranged such that adjacent magnetic poles 332c have opposite polarities. In this manner, the developer supplied from the pickup roll 333 (refer to FIG. 2) is stuck to the sleeve 332b by the magnetic field generated by the magnetic poles 332c, and is transported toward the opening portion 331a along with the rotation of the sleeve 332b.

Here, the toner contained in the developer is conveyed by the first conveyance portion 334, the second conveyance portion 335, and the third conveyance portion 336, and is charged while being agitated. Then, the developing roll 332 faces the photosensitive drum 31 that is charged to a polarity different from the polarity of the toner, at the opening portion 331a. Therefore, in a case where the developer reaches the opening portion 331a transported by the rotation of the sleeve 332b, the toner contained in the developer is stuck to the photosensitive drum 31. Thereafter, the developer containing the carrier and the toner remaining without being stuck to the photosensitive drum 31 is further transported by the rotation of the sleeve 332b to return to the accommodation portion 331, and is scraped off from the sleeve 332b by the removal member 338 (refer to FIG. 2).

The developer is transported on the surface of the developing roll 332 in this manner, but during this process, a part of the developer adhering to the developing roll 332 is separated on the downstream side of the regulation member 337 in the rotation direction of the developing roll 332. For example, a part of the developer scraped off by the regulation blade 337b reaches the space S over the regulation blade 337b. In addition, the layer of the developer after being scraped off by the regulation blade 337b may be separated by the movement of the sleeve 332b or by coming into contact with the surface of the cover 339 that faces the developing roll 332. The developer separated from the developing roll 332 floats in the space S, or is scattered outward from the end portion of the cover 339 on the downstream side (the opening portion 331a side) in the rotation direction of the developing roll 332. Therefore, a configuration is provided in which the developer separated from the developing roll 332 is caused to flow in and discharged.

Specifically, the gap between the cover 339 and the outer shell 60 of the developing device 33 is used as a flow path for sucking in and discharging the developer scattered from the opening portion 331a side of the cover 339 (refer to dashed arrow 51 of FIG. 4). The flow path is referred to as a “flow path 51”. The flow path 51 is an example of a first flow path. In addition, a gap is provided between the guide piece 339b of the cover 339 and the regulation blade 337b to form a flow path for discharging the developer floating in the space S (refer to dashed arrow 52 of FIG. 4). The flow path is referred to as a “flow path 52”. The flow path 52 is an example of a second flow path. The developer separated from the developing roll 332 is guided to the space 50 (refer to FIG. 3) by the two flow paths 51 and 52 and is discharged.

### Structure of Discharge Flow Path of Developer

Next, the structure of the discharge flow path of the developer, which includes the flow paths 51 and 52, will be described with reference to FIGS. 3 and 4. As described above, as the flow path for discharging the developer separated from the surface of the developing roll 332, the flow path 51 and the flow path 52 are provided. The two flow paths 51 and 52 merge in the middle and are connected to the space 50. The space 50 forms the flow path and is connected to the exhaust device, and the flow path of the air reaching the exhaust device from the flow paths 51 and 52 through the space 50 is formed by the exhaust device sucking the air. According to the flow of the air, the developer floating in the space S or near the opening portion 331a flows into the flow paths 51 and 52, and is discharged through the space 50. The flow path including the space 50 and the exhaust device will be described later.

In a case where the flow path 51 and the flow path 52 are compared with each other, in the cross section illustrated in FIG. 4, the flow path 52 is narrower than the flow path 51. Therefore, in a case where the air is sucked from the space 50 where the flow path 51 and the flow path 52 merge, the negative pressure in the flow path 52 is higher than the negative pressure in the flow path 51. With such a configuration, the developer floating or staying between the cover portion 339a of the cover 339 and the developing roll 332 is pulled back to the upstream side in the rotation direction of the developing roll 332 and is discharged from the flow path 52. In this manner, a larger amount of developer is sucked into the flow path 52, and the scattering of the developer on the opening portion 331a side is suppressed.

The inlets of the flow paths 51 and 52 will be further described. As illustrated in FIG. 4, the flow path 51 is formed by an outer surface of the cover 339 and an inner surface of the outer shell 60 of the developing device 33. Then, the inlet of the flow path 51 is formed by an end portion of the cover 339 on the downstream side (the opening portion 331a side) in the rotation direction of the developing roll 332 and an end portion of the outer shell 60 on the opening portion 331a side. In this manner, the developer that is scattered and floats near the opening portion 331a over the cover 339 is sucked from the inlet of the flow path 51 toward the flow path 51. The inlet of the flow path 51 is an example of a first inlet.

The flow path 52 is formed by the facing surfaces of the guide piece 339b of the cover 339 and the regulation blade 337b of the regulation member 337. Then, the inlet of the flow path 52 is formed by the end portions of the facing surfaces of the guide piece 339b and the regulation blade 337b, the end portions being on the space S side. In this manner, the developer separated from the developing roll 332 in the space S is sucked from the inlet of the flow path 52 toward the flow path 52. The inlet of the flow path 52 is an example of a second inlet.

In more detail, the inlet of the flow path 52 is provided at a position facing a part between two adjacent magnetic poles 332c among the magnetic poles 332c provided on the shaft member 332a of the developing roll 332, in the part of the surface of the developing roll 332. In the example illustrated in FIG. 4, the inlet of the flow path 52 is provided at a position facing a substantially central part between the two adjacent magnetic poles 332c. As described above, on the surface of the developing roll 332, the developer is stuck to the sleeve 332b by the magnetic field generated by the magnetic poles 332c. In addition, as described above, the magnetic poles 332c are arranged such that adjacent magnetic poles 332c have opposite polarities. Due to such a configuration, the developer stuck to the sleeve 332b forms a stacked layer shaped like a row of ears such that the developer rises from the surface of the sleeve 332b at the position of the magnetic poles 332c. Then, in a case where the developer is transported away from the magnetic poles 332c along with the rotation of the sleeve 332b, the layer of the developer gradually falls off in the rotation direction of the sleeve 332b. In a case where the sleeve 332b further rotates and the layer of the developer approaches the next magnetic pole 332c, the layer of the developer gradually rises in an inverted manner in a state where the fallen tip side is in contact with the surface of the sleeve 332b. In this process, since the magnetic field is weakened between two magnetic poles 332c in which the layer of the developer falls down, the developer is more easily separated from the surface of the sleeve 332b than in a case where the layer of the developer is positioned above any of the magnetic poles 332c. Therefore, by positioning the inlet of the flow path 52 at a position facing the part between two adjacent magnetic poles 332c, the developer separated from the surface of the sleeve 332b efficiently flows into the flow path 52.

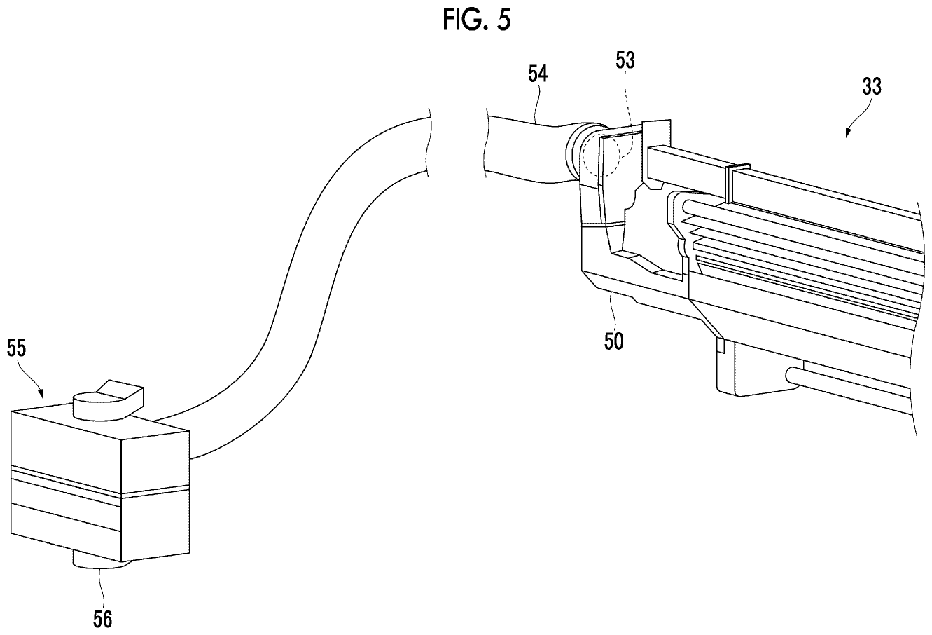

FIG. 5 is a diagram illustrating the discharge route of the developer continuing from the space 50 illustrated in FIG. 3. FIG. 5 illustrates a part of the rear side of the developing device 33, a suction hose 54 connected to the developing device 33, and an exhaust device 55. In FIG. 5, the space 50 is not illustrated, but a duct part where the air flows from the developing device 33 to the suction hose 54 is denoted by the reference numeral 50. One end of the suction hose 54 is connected to a through-hole 53 provided at the end portion of the duct part of the developing device 33. The other end of the suction hose 54 is connected to the exhaust device 55. For example, the exhaust device 55 is arranged on the back surface (back side in FIG. 1) of the printing unit 1B (refer to FIG. 1) of the image forming apparatus 1.

The exhaust device 55 is provided with a fan 56, and the air in the space 50 of the developing device 33 is sucked via the suction hose 54 due to the rotation of the fan 56. In this manner, the floating developer is sucked together with the air from the inlets of the flow paths 51 and 52, and is discharged to the exhaust device 55 through the flow paths 51 and 52, the space 50, and the suction hose 54. In addition, the exhaust device 55 is provided with a filter (not illustrated), which collects the developer discharged together with the air from the developing device 33. The space 50, the suction hose 54, and the exhaust device 55 are examples of a suction portion.

The exemplary embodiments of the disclosure have been described above, but the technical scope of the present disclosure is not limited to the above exemplary embodiments. The present disclosure includes various modifications and alternative configurations that do not depart from the scope of the technical idea of the present invention.

### Supplementary Note

(((1)))

A developing apparatus comprising:
a developer holder that supplies a developer to an image holder on which an electrostatic latent image is formed;
a regulation member that regulates an amount of the developer held by the developer holder;
a shielding member that covers a part of the developer holder and the regulation member; and
a suction portion that has, in a covering region covered by the shielding member of the developer holder, a first flow path allowing air to flow in from a first inlet provided on a downstream side of a movement of the developer holder, and a second flow path allowing air to flow in from a second inlet provided on an upstream side of the movement of the developer holder, and that sucks the air via the first flow path and the second flow path.

(((2)))

The developing apparatus according to (((1))),
wherein the first flow path and the second flow path of the suction portion merge in the middle to form one flow path.

(((3)))

The developing apparatus according to (((1))) or ((((2)))
wherein the second flow path is narrower than the first flow path.

(((4)))

The developing apparatus according to any one of (((1))) to (((3)))
wherein the developer holder includes a rotating developing sleeve, and a magnet roll that has a plurality of magnetic poles and is provided inside the developing sleeve, and
the second inlet of the suction portion is provided at a position facing a part between two of the magnetic poles in the developer holder.

(((5)))

The developing apparatus according to (((4))),
wherein the second inlet is provided at a position facing a substantially central part between two of the magnetic poles in the developer holder.

(((6)))

The developing apparatus according to any one of (((1))) to (((5))),
wherein the second flow path of the suction portion has a higher negative pressure than a negative pressure of the first flow path.

(((7)))

The developing apparatus according to any one of (((1))) to (((6))),
wherein the second flow path of the suction portion is formed as a gap between the regulation member and the shielding member.

(((8)))

An image forming apparatus comprising the developing apparatus according to any one of (((1))) to (((7))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing apparatus comprising:
a developer holder that supplies a developer to an image holder on which an electrostatic latent image is formed;
a regulation member that regulates an amount of the developer held by the developer holder;
a shielding member that covers a part of the developer holder and the regulation member; and
a suction portion that has, in a covering region covered by the shielding member of the developer holder, a first flow path allowing air to flow in from a first inlet provided on a downstream side of a movement of the developer holder, and a second flow path allowing air to flow in from a second inlet provided on an upstream side of the movement of the developer holder, and that sucks the air via the first flow path and the second flow path.

2. The developing apparatus according to claim 1,
wherein the first flow path and the second flow path of the suction portion merge in the middle to form one flow path.

3. The developing apparatus according to claim 2,
wherein the second flow path is narrower than the first flow path.

4. The developing apparatus according to claim 1,
wherein the developer holder includes a rotating developing sleeve, and a magnet roll that has a plurality of magnetic poles and is provided inside the developing sleeve, and
the second inlet of the suction portion is provided at a position facing a part between two of the magnetic poles in the developer holder.

5. The developing apparatus according to claim 4,
wherein the second inlet is provided at a position facing a substantially central part between two of the magnetic poles in the developer holder.

6. The developing apparatus according to claim 1,
wherein the second flow path of the suction portion has a higher negative pressure than a negative pressure of the first flow path.

7. The developing apparatus according to claim 1,
wherein the second flow path of the suction portion is formed as a gap between the regulation member and the shielding member.

8. An image forming apparatus comprising the developing apparatus according to claim 1.

9. An image forming apparatus comprising the developing apparatus according to claim 2.

10. An image forming apparatus comprising the developing apparatus according to claim 3.

11. An image forming apparatus comprising the developing apparatus according to claim 4.

12. An image forming apparatus comprising the developing apparatus according to claim 5.

13. An image forming apparatus comprising the developing apparatus according to claim 6.

14. An image forming apparatus comprising the developing apparatus according to claim 7.
